(19) United States
(12) Patent Application Publication
(10) Pub. No.: US 2026/0172110 A1
(43) Pub. Date: Jun. 18, 2026

(54) NETWORK CONTROL DEVICE AND OPTICAL NETWORK SYSTEM

(71) Applicant: 1FINITY Inc., Kawasaki-shi (JP)

(72) Inventor: Atsushi KODAMA, Kawasaki (JP)

(73) Assignee: 1FINITY Inc., Kawasaki-shi (JP)

(21) Appl. No.: 19/417,950

(22) Filed: Dec. 12, 2025

(30) Foreign Application Priority Data
Dec. 13, 2024 (JP) 2024-218669

(51) Int. Cl. H04B 10/07; H04J 14/02

(52) U.S. Cl. CPC H04B 10/07; H04J 14/0221; H04J 14/0227

(57) ABSTRACT

There is provided a network control device for controlling a plurality of devices included in an optical network. The network control device includes an acquirer that acquires first information indicating a transmission state of each of an optical transceiver, a first wavelength division multiplexing (WDM) device connected to the optical transceiver via a first transmission line, and a second WDM device connected to the first WDM device via a second transmission line different from the first transmission line from at least one of the optical transceiver, the first WDM device, and the second WDM device, a calculator that calculates transmission performance in the first transmission line based on the first information, and a setting changer that changes a setting of at least one of the optical transceiver, the first WDM device, and the second WDM device based on the transmission performance in the first transmission line.

### CROSS-REFERENCE TO RELATED APPLICATION

This application is based upon and claims the benefit of priority of the prior Japanese Patent Application No. 2024-218669, filed on Dec. 13, 2024, the entire contents of which are incorporated herein by reference.

### FIELD

A certain aspect of embodiments described herein relates to a network control device and an optical network system.

### BACKGROUND

In an optical communication system, a wavelength division multiplexing (WDM) method is used for multiplexing and transmitting optical signals of respective wavelengths in order to realize communication with a large capacity. In the WDM method, a WDM signal composed of a plurality of optical signals having different wavelengths is transmitted over a single optical fiber. In an optical communication system employing the WDM method, a wavelength selective switch (WSS) for controlling transmission of an optical signal in a wavelength unit is provided. The WSS has a bandwidth variable function and an attenuation amount adjustment function, and can control the optical attenuation amount of the WDM signal (see, for example, International Publication No. 2019/188633, International Publication No. 2019/107471, International Publication No. 2023/181388, U.S. Patent Application Publication No. 2016/0164597, and U.S. Patent Application Publication No. 2024/0259096).

An all-optical network utilizing the WDM method is also known. In an optical communication system constituting the all-optical network, a plurality of transmission terminals and a plurality of reception terminals are connected end-to-end by light without involving photoelectric conversion. An optical signal transmitted from a transmission terminal is input to any one of relay nodes, and a path is switched for each wavelength, and then the optical signal is transferred to a reception terminal. It is also known that the function of a relay node is added to a reconfigurable optical add/drop multiplexer (ROADM) device (see, for example, International Publication No. 2023/112326).

### SUMMARY

According to an aspect of the embodiments, there is provided a network control device for controlling a plurality of devices included in an optical network. The network control device includes an acquirer that acquires first information indicating a transmission state of each of an optical transmission and reception device, a first wavelength division multiplexing device connected to the optical transmission and reception device via a first transmission line, and a second wavelength division multiplexing device connected to the first wavelength division multiplexing device via a second transmission line different from the first transmission line from at least one of the optical transmission and reception device, the first wavelength division multiplexing device, and the second wavelength division multiplexing device, a calculator that calculates transmission performance in the first transmission line based on the first information, and a setting changer that changes a setting of at least one of the optical transmission and reception device, the first wavelength division multiplexing device, and the second wavelength division multiplexing device based on the transmission performance in the first transmission line.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an example of an optical network.

FIG. 2 is a diagram for explaining an example of a remote transponder.

FIG. 3 is a diagram for explaining an example of a first photonic gateway and a first ROADM device.

FIG. 4 is a diagram for explaining an example of a second ROADM device.

FIG. 5 is a diagram for explaining an example of an N-th photonic gateway and an N-th ROADM device.

FIG. 6 is a diagram for explaining another example of the remote transponder.

FIG. 7 is a diagram for explaining an example of a functional configuration of an NMS.

FIG. 8A is a diagram for explaining an example of a slot width before a setting change.

FIG. 8B is a diagram for explaining an example of the slot width after the setting change.

FIG. 9 is a flowchart illustrating an example of an operation of the NMS.

FIG. 10 is a diagram for explaining a comparative example.

FIG. 11 is a diagram for explaining an example according to a first embodiment.

FIG. 12 is a diagram for explaining another example according to the first embodiment.

FIG. 13 is a diagram for explaining an example of an effect of a first transmission model #1 according to the first embodiment.

FIG. 14 is a diagram for explaining an example of the effect of a second transmission model #2 according to the first embodiment.

FIG. 15 is a diagram for explaining an example of the effect of a third transmission model #3 according to the first embodiment.

FIG. 16 is a diagram for explaining an example of a second embodiment.

FIG. 17 is a diagram for explaining an example of a third embodiment.

FIG. 18 is a diagram for explaining an example of a fourth embodiment.

### DESCRIPTION OF EMBODIMENTS

Incidentally, there is a case where an optical transceiver (e.g., a transponder) including an optical transmitter for transmitting an optical signal (hereinafter referred to as a signal light) and an optical receiver for receiving the signal light is connected to or mounted on the ROADM device. Optical transceiver and ROADM equipment are often placed in a same optical network managed by a communication carrier.

On the other hand, it is also considered to arrange the optical transceiver in a communication network managed by an end user of the communication carrier and to extend the optical network where the ROADM device is arranged to a portion where the optical transceiver is arranged. The end user of the communication carrier is a business operator who uses communication services provided by the communication carrier as an end customer.

The Optical network managed by the communication carrier and the communication network managed by the end user are often separated. When the optical transceiver is remotely located away from the ROADM device, the transmission performance of the optical path may be degraded due noises generated in a transmission line in a separated section.

Hereinafter, a description will be given of embodiments of the present matter with reference to the accompanying drawings.

### First Embodiment

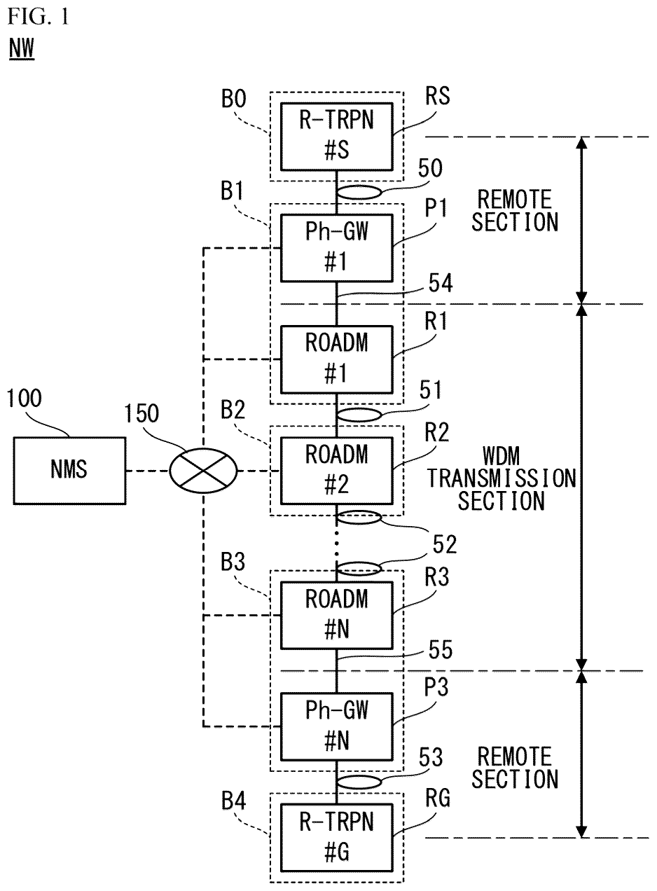

As illustrated in FIG. 1, the optical network NW includes a plurality of remote transponders (denoted as R-TRPN in FIG. 1) RS, RG, a plurality of photonic gateways (denoted as Ph-GW in FIG. 1) P1, P3, and a plurality of ROADM devices R1, R2, . . . , R3.

The remote transponders RS and RG are an example of the optical transmission and reception device. A device including a combination of the photonic gateway P1 and the ROADM device R1 and a device including a combination of the photonic gateway P3 and the ROADM device R3 are an example of the first WDM device. The ROADM device R2 is an example of the second WDM device. A device installed in station buildings B0 and B4, which will be described later, may be an example of the transmission and reception device. A device installed in station buildings B1 and B3, which will be described later, may be an example of the first WDM device. A device installed in a station building B2, which will be described later, may be an example of the second WDM device. The photonic gateways P1 and P3 may be the first optical device, and the ROADM devices R1 and R3 may be the second optical device.

Remote transponders RS and RG are provided on terminal stations of the optical network NW. The photonic gateways P1 and P3 and the ROADM devices R1, R2, . . . , and R3 are provided on non-terminal stations (e.g., a relay station, a switching station, etc.) excluding the terminal stations from the optical network NW. The terminal stations are located remotely from the non-terminal stations.

The remote transponder RS is installed in the station building B0 located at the terminal station. The station building B0 is a station building of the end user of the communication carrier. The station building B0 may be a station building of the business operator who operates the data center. Although the details will be described later, the remote transponder RS can individually transmit a plurality of remote signal lights having wavelengths different from each other. Therefore, the station building B0 corresponds to a start point of the plurality of remote signal lights.

The photonic gateway P1 and the ROADM device R1 are installed in the station building B1 located in the non-terminal station. The station building B1 is located at a first position when the station building B0 is taken as a base point. The ROADM device R2 is installed in the station building B2 located in the non-terminal station. The station building B2 is located a second position when the station building B0 is taken as the base point. The ROADM device R3 and the photonic gateway P3 are installed in the station building B3 located in the non-terminal station. The station building B3 is located at an N-th position (N is a natural number of 3 or more) when the station building B0 is taken as the base point. All of the station buildings B1, B2, and B3 are the station buildings of the communication carriers.

The remote transponder RG is installed in the station building B4 located at the terminal station. The station building B4 is the station building of the end user or the business operator. The remote transponder RG can individually receive a plurality of remote signal lights having wavelengths different from each other. Therefore, the station building B4 corresponds to a goal point of the remote signal light.

As described above, in the optical network NW according to the present embodiment, the remote transponders RS and RG installed in the station buildings B0 and B4 of the end users different from the communication carriers are used. That is, the remote transponders RS and RG belong partially to the communication network of the end user. Therefore, the remote transponders RS and RG are managed by the end user, not by the communication carriers. On the other hand, the photonic gateways P1 and P3 and the ROADM devices R1, R2, . . . , and R3 are managed by the communication carriers.

The remote transponder RS and the photonic gateway P1 are connected to each other by a transmission line 50. The ROADM devices R1 and R2 are connected to each other by a transmission line 51. The ROADM devices R2, . . . , and R3 are connected to each other by a transmission line 52. The photonic gateway P3 and the remote transponder RG are connected to each other by a transmission line 53. Each of the transmission lines 50, 51, 52, and 53 include an optical fiber. The transmission lines 50 and 53 are an example of a first transmission line, and the transmission lines 51 and 52 are an example of a second transmission line. For example, the transmission lines 50, 51, 52, and 53 include the optical fiber such as a single-mode optical fiber used for long-distance transmission. An optical in-line amplifier (ILA) may be installed in a middle of each transmission line 50, 51, 52, and 53.

On the other hand, since the photonic gateway P1 and the ROADM device R1 are both installed in the station building B1, they are connected to each other by an optical fiber 54. Since both the ROADM device R3 and the photonic gateway P3 are installed in the station building B3, they are connected to each other by an optical fiber 55. The optical fibers 54 and 55 are, for example, a multimode optical fiber used for short-distance transmission. As described above, the optical fibers 54 and 55 is different from the optical fiber included in the transmission line 50, 51, 52, and 53 in type.

In the present embodiment, the WDM light propagates between the ROADM devices R1, R2, . . . , and R3. The WDM light is a signal light in which a plurality of remote signal lights having different wavelengths are multiplexed. Therefore, a section including the ROADM devices R1, R2, . . . , and R3 is called a WDM transmission section. On the other hand, a section including the transmission line 50 and the photonic gateway P1 and a section including the transmission line 53 and the photonic gateway P3 are called a remote section, respectively. The remote section partially includes the remote transponders RS and RG, but may include the remote transponders RS and RG as a whole. The remote section is an example of the first section, and the WDM transmission section is an example of the second section.

The photonic gateways P1 and P3 and the ROADM devices R1, R2, . . . , and R3 are electrically connected to an network management system (NMS) 100 managed and operated by the communication carrier. The NMS 100 is an example of a network control device. The NMS 100 controls the operations of the photonic gateway P1, the ROADM device R1, and the like through a communication network 150. The communication network 150 is, for example, a data communication network (DCN), and includes at least one of a local area network (LAN), a wide area network (WAN), and the Internet.

The remote transponders RS and RG are not directly connected to the communication network 150. As will be described in detail later, the NMS 100 acquires various information indicating a transmission state of each of the photonic gateway P1, the ROADM device R1, and the like. Upon acquiring the information, the NMS 100 executes control for improving the transmission performance of the optical network NW with respect to the ROADM device R1 and the like based on the acquired information. The extension of the transmission distance in the optical network NW is realized by the improvement of the transmission performance.

The optical network system is realized by the remote transponder RS, the photonic gateway P1, the ROADM device R1, and the NMS 100. The optical network system may be realized by the ROADM device R3, the photonic gateway P3, the remote transponder RG, and the NMS 100.

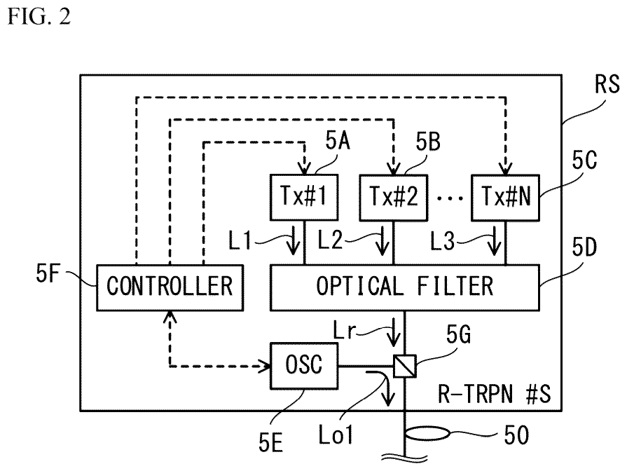

Referring to FIGS. 2 to 6, the details of the remote transponders RS and RG, the photonic gateways P1 and P3, and the ROADM devices R1, R2, . . . , and R3 will be described.

First, referring to FIG. 2, the remote transponder RS will be described. The remote transponder RS includes a plurality of optical transmitters 5A, 5B, . . . , and 5C, an optical filter 5D, an OSC communicator 5E, and a controller 5F. Although not illustrated, the remote transponder RS may include a plurality of optical receivers.

The optical transmitter 5A transmits a remote signal light L1 of a single wavelength based on control of the controller 5F. The optical transmitter 5B transmits a remote signal light L2 having a single wavelength based on control of the controller 5F. The optical transmitter 5C transmits a remote signal light L3 having a single wavelength based on control of the controller 5F. The optical transmitters (not illustrated) other than the optical transmitters 5A, 5B, and 5C also transmit a remote signal light in the same manner as the optical transmitters 5A, 5B, and 5C. The single wavelengths of the remote signal lights L1, L2, L3, etc. transmitted by the optical transmitters 5A, 5B, . . . , and 5C are different from each other.

The optical filter 5D includes an optical coupler such as a coupler for multiplexing. Accordingly, when the remote signal lights L1, L2, L3, etc. are input to the optical filter 5D, the remote signal lights L1, L2, L3, etc. are multiplexed by the optical filter 5D and output from the optical filter 5D as a remote multiplexed light Lr. Thus, the remote multiplexed light Lr is output from the remote transponder RS to the transmission line 50.

For example, when any one of the remote signal lights L1, L2, and L3 is input to the optical filter 5D, any one of the input remote signal lights L1, L2, and L3 is output from the optical filter 5D. In this case, any one of the remote signal lights L1, L2, and L3 is output from the remote transponder RS to the transmission line 50 as the remote multiplexed light Lr.

The OSC communicator 5E transmits an optical supervisory channel (OSC) light Lo1 based on the control by the controller 5F. The OSC light Lo1 includes, for example, a transmitter output power obtained by adding up the output powers of the optical transmitters 5A, 5B, . . . , and 5C. The transmitter output power may be referred to as the power with which the remote transponder RS inputs the remote multiplexed light Lr to the transmission line 50. The OSC communicator 5E is connected to the optical path through which the remote multiplexed light Lr propagates through an OSC coupler 5G. As a result, the OSC light Lo1 is output from the remote transponder RS to the transmission line 50. Although the details will be described later, when the OSC light Lo1 is input to the remote transponder RS, the OSC communicator 5E can also receive the OSC light Lo1.

The controller 5F is electrically connected to the optical transmitters 5A, 5B, . . . , and 5C and the OSC communicator 5E. The controller 5F can control the operations of the optical transmitters 5A, 5B, . . . , and 5C and the OSC communicator 5E. For example, the controller 5F can independently control the optical transmitter 5A to individually transmit the remote signal light L1 to the optical transmitter 5A. The controller 5F can control the OSC communicator 5E to transmit the OSC light Lo1 to the OSC communicator 5E. The controller 5F can change a setting of a symbol rate of the optical transmitters 5A, 5B, . . . , and 5C based on the OSC light Lo1 received by the OSC communicator 5E.

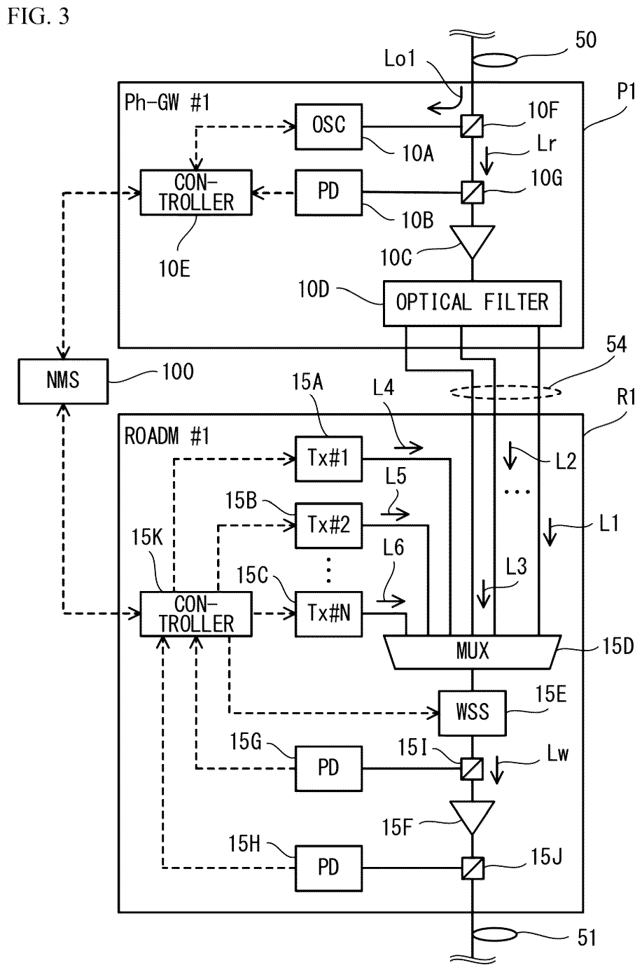

Next, referring to FIG. 3, the photonic gateway P1 and the ROADM device R1 will be described.

First, the photonic gateway P1 will be described. The photonic gateway P1 includes an OSC communicator 10A, a photo diode (PD) 10B, a reception amplifier 10C, an optical filter 10D, and a controller 10E. The reception amplifier 10C is an example of a first amplifier.

The OSC communicator 10A receives the OSC light Lo1 propagated through the transmission line 50 via an OSC splitter 10F. Since the OSC light Lo1 includes the transmitter output power described above, the OSC communicator 10A can output the transmitter output power to the controller 10E. The OSC communicator 10A can transmit the OSC light Lo1 based on the control by the controller 10E. The OSC light Lo1 includes, for example, an instruction to change the setting of the symbol rate. The OSC light Lo1 transmitted by the OSC communicator 10A is output from the photonic gateway P1 to the transmission line 50. Thus, the OSC communicator 5E of the remote transponder RS can receive the OSC light Lo1.

The PD 10B is connected to the optical path, through which the remote multiplexed light Lr propagates, via a branch coupler 10G. Thus, the PD 10B can detect the optical power of the remote multiplexed light Lr. The PD 10B is disposed upstream or in front of the reception amplifier 10C. Therefore, when the PD 10B detects the optical power of the remote multiplexed light Lr, the PD 10B can output the optical power of the remote multiplexed light Lr to the controller 10E as an amplifier input power of the reception amplifier 10C.

The reception amplifier 10C is an optical amplifier including, for example, an erbium doped fiber amplifier (EDFA). The reception amplifier 10C receives and amplifies the remote multiplexed light Lr. The reception amplifier 10C amplifies the remote multiplexed light Lr and outputs the remote multiplexed light Lr to the optical filter 10D.

The optical filter 10D includes an optical coupler such as a coupler for wavelength division multiplexing. Therefore, when the remote multiplexed light Lr obtained by multiplexing the remote signal lights L1, L2, and L3 is input to the optical filter 10D, the remote multiplexed light Lr is demultiplexed by the optical filter 10D, and the remote signal lights L1, L2, and L3 are individually output from the optical filter 10D. For example, when the remote signal light L1 is input to the optical filter 10D as the remote multiplexed light Lr, the remote signal light L1 is output from the optical filter 10D alone.

The controller 10E is electrically connected to the OSC communicator 10A and the PD 10B. The controller 10E can control the operation of the OSC communicator 10A. For example, the controller 10E can control the OSC communicator 10A to cause the OSC communicator 10A to transmit the OSC light Lo1. When the transmitter output power output from the OSC communicator 10A and the amplifier input power output from the PD 10B are input, the controller 10E can output the transmitter output power and the amplifier input power to the NMS 100.

Next, the ROADM device R1 will be described. The ROADM device R1 includes a plurality of optical transmitters 15A, 15B, . . . , and 15C, and a multiplexer (denoted as MUX in FIG. 3. The same is described in the following drawings) 15D, a WSS 15E, a WDM amplifier 15F, PDs 15G and 15H, and a controller 15K.

The optical transmitter 15A transmits a local signal light L4 having a single wavelength based on a control of the controller 15K. The optical transmitter 15B transmits a local signal light L5 having a single wavelength based on the control of the controller 15K. The optical transmitter 15C transmits a local signal light L6 having a single wavelength based on the control of the controller 15K. Optical transmitters (not illustrated) other than the optical transmitters 15A, 15B, and 15C also transmit the local signal light in the same manner as the optical transmitters 15A, 15B, and 15C. The single wavelengths of the local signal lights L4, L5, L6, etc. transmitted by the optical transmitters 15A, 15B, . . . , and 15C are different from each other.

The multiplexer 15D multiplexes the remote signal lights L1, L2, and L3 and the local signal lights L4, L5, and L6. That is, the multiplexer 15D generates a WDM light Lw by multiplexing the remote signal lights L1, L2, and L3 and the local signal lights L4, L5, and L6. Upon generation of the WDM light Lw, the multiplexer 15D outputs the WDM light Lw to the downstream of the optical network NW. There is a case where the remote multiplexed light Lr includes the remote signal light L1 alone and the optical transmitter 15A transmits the local signal light L5 having a wavelength different from that of the remote signal light L1 alone. In this case, the multiplexer 15D generates and outputs the WDM light Lw obtained by multiplexing the remote signal light L1 and the local signal light L5.

The WSS 15E increases the optical power of the WDM light Lw based on the control by the controller 15K. For example, when the WDM light Lw obtained by multiplexing the remote signal light L1 and the local signal light L5 is input, the WSS 15E increases the optical power of the remote signal light L1 while maintaining the optical power of the local signal light L5 based on a control of an attenuation amount of the WSS 15E by the controller 15K. This reduces an amount of noise occurred in the transmission line 50 provided in the remote section relative to the remote signal light L1.

Since the optical power of the remote signal light L1 is increased while the optical power of the local signal light L5 is maintained, the optical power of the WDM light Lw is increased as a result. Therefore, the input power of the WDM light Lw input to the WDM amplifier 15F provided as a post amplifier in the subsequent stage of the WSS 15E increases. Thus, even if the WDM light Lw propagates through the transmission lines 51 and 52 provided in the WDM transmission section, noise occurred in the WDM transmission section is reduced as compared with the case where the optical power of the remote signal light L1 is not increased.

The WSS 15E may include a multiplexer 15D. Further, as will be described in detail later, the controller 15K changes (for example, adjusts or enlarges) a slot width of a slot of the WSS 15E, so that the WSS 15E can increase the optical power of the remote signal light L1 while maintaining the optical power of the local signal light L5. That is, under automatic level control (ALC) described later, the WSS 15E can increase the optical power of the channel to be changed without affecting the optical power of the channels other than the channel to be changed. For example, when the slot width is increased, the maximum number of channels of the WDM light Lw output from the WSS 15E to the WDM amplifier 15F is limited.

The WDM amplifier 15F is an optical amplifier including, for example, the EDFA. The WDM amplifier 15F receives the WDM light Lw and amplifies the WDM light Lw in the ALC mode. The ALC is sometimes called automatic power control (APC) or automatic gain control (AGC). The WDM amplifier 15F amplifies the WDM light Lw and outputs the WDM light Lw to the transmission line 51.

The PD 15G is connected to an optical path, through which the WDM light Lw propagates, via a branch coupler 15I. Thus, the PD 15G can detect the optical power of the WDM light Lw. The branch coupler 15I is provided upstream or in front of the WDM amplifier 15F. Therefore, when the PD 15G detects the optical power of the WDM light Lw, the PD 15G can output the optical power of the WDM light Lw to the controller 15K as an amplifier input power of the WDM amplifier 15F.

The PD 15H is connected to the optical path, through which the WDM light Lw propagates, via a branch coupler 15J. Thus, the PD 15H can detect the optical power of the WDM light Lw. The branch coupler 15J is provided downstream or in the subsequent stage of the WDM amplifier 15F. Therefore, when the PD 15H detects the optical power of the WDM light Lw, the PD 15H can output the optical power of the WDM light Lw to the controller 15K as an amplifier output power of the WDM amplifier 15F.

The controller 15K is electrically connected to the optical transmitters 15A, 15B, . . . , and 15C, the WSS 15E, and the PDs 15G, and 15H. The controller 15K can control operations of the optical transmitters 15A, 15B, . . . , and 15C and the WSS 15E.

For example, the controller 15K can independently control the optical transmitter 15B to transmit the local signal light L5 to the optical transmitter 15B. The controller 15K can control the WSS 15E to change a slot width of the WSS 15E. The controller 15K can output the optical power of the WDM light Lw detected by the PDs 15G and 15H to the NMS 100 as the amplifier input power and the amplifier output power, respectively.

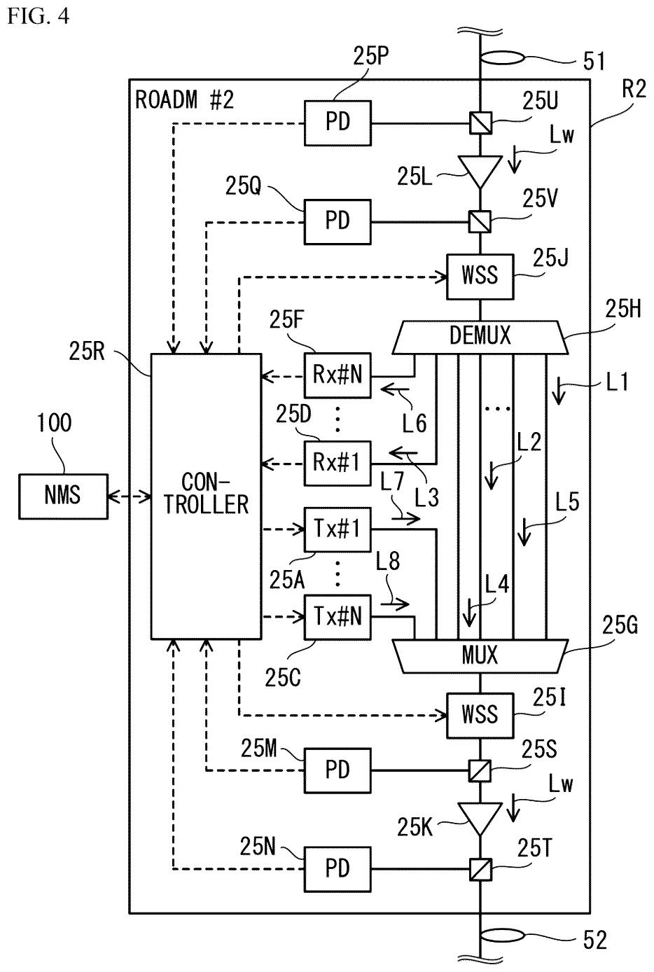

Next, referring to FIG. 4, the ROADM device R2 will be described. The ROADM device R2 includes a plurality of optical transmitters 25A, . . . , and 25C, a plurality of optical receivers 25D, . . . , and 25F, a multiplexer 25G, and a demultiplexer (denoted as DEMUX in FIG. 4. The same is described in the following drawings) 25H. The ROADM device R2 includes WSSs 25I and 25J, WDM amplifiers 25K and 25L, PDs 25M, 25N, 25P, and 25Q, and a controller 25R.

The WDM amplifier 25L is an optical amplifier including, for example, the EDFA. The WDM amplifier 25L, as a preamplifier provided in the preceding stage of the WSS 25J, receives the WDM light Lw input to the ROADM device R2 and amplifies the WDM light Lw in the ALC mode. The WDM amplifier 25L amplifies the WDM light Lw and outputs the WDM light Lw to the downstream of the WDM amplifier 25L.

The PD 25P is connected to an optical path, through which the WDM light Lw propagates, via a branch coupler 25U. Thus, the PD 25P can detect the optical power of the WDM light Lw. The branch coupler 25U is provided upstream or in front of the WDM amplifier 25L. Therefore, when the PD 25P detects the optical power of the WDM light Lw, the PD 25P can output the optical power of the WDM light Lw to the controller 25R as an amplifier input power of the WDM amplifier 25L.

The PD 25Q is connected to an optical path, through which the WDM light Lw propagates, via a branch coupler 25V. Thus, the PD 25Q can detect the optical power of the WDM light Lw. The branch coupler 25V is provided downstream or in the subsequent stage of the WDM amplifier 25L. Therefore, when the PD 25Q detects the optical power of the WDM light Lw, the PD 25Q can output the optical power of the WDM light Lw to the controller 25R as an amplifier output power of the WDM amplifier 25L.

The WSS 25J increases the optical power of the WDM light Lw based on a control by the controller 25R. For example, when the WDM light Lw obtained by multiplexing the remote signal light L1 and the local signal light L5 is input, the WSS 25J increases the optical power of the remote signal light L1 while maintaining the optical power of the local signal light L5 based on the control of the controller 25R. This reduces the amount of noise occurred in the transmission line 50 provided in the remote section relative to the remote signal light L1. Since the optical power of the remote signal light L1 is increased while the optical power of the local signal light L5 is maintained, the optical power of the WDM light Lw is increased as a result.

The demultiplexer 25H demultiplexes the WDM light Lw output from the WSS 25J into, for example, remote signal lights L1, L2, and L3 and local signal lights L4, L5, and L6. When the demultiplexer 25H demultiplexes the WDM light Lw, the demultiplexer 25H outputs, for example, the remote signal lights L1 and L2 and the local signal light L4 to the downstream of the demultiplexer 25H, and outputs the remote signal light L3 and the local signal light L6 to the optical receivers 25D and 25F.

The optical receiver 25D receives the remote signal light L3. The optical receiver 25D may receive the remote signal lights L1, L2, etc. The optical receiver 25F receives the local signal light L6. The optical receiver 25F may receive the local signal lights L4 and L5. Optical receivers (not illustrated) other than the optical receivers 25D and 25F also receive the remote signal light or the local signal light in the same manner as the optical receivers 25D and 25F. The optical receivers 25D, 25F, etc. convert the remote signal light L3, the local signal light L6, etc. into electric digital signals. The controller 25R measures signal qualities of the remote signal light L3 and the local signal light L6 based on the digital signals.

The optical transmitter 25A transmits a local signal light L7 having a single wavelength based on the control of the controller 25R. The optical transmitter 25C transmits a local signal light L8 having a single wavelength based on the control of the controller 25R. Optical transmitters (not illustrated) other than the optical transmitters 25A and 25C also transmit the local signal light in the same manner as the optical transmitters 25A and 25C. The single wavelengths of the local signal lights L7, L8, etc. transmitted by the optical transmitters 25A, . . . , and 25C are different from each other.

The multiplexer 25G multiplexes the remote signal lights L1 and L2 and the local signal lights L4, L5, L7, and L8. That is, the multiplexer 25G generates the WDM light Lw by multiplexing the remote signal lights L1 and L2 and the local signal lights L4, L5, L7, and L8. When the multiplexer 25G generates the WDM light Lw, the multiplexer 25G outputs the WDM light Lw to the downstream of the optical network NW. The multiplexer 25G may generate and output the WDM light Lw obtained by multiplexing the remote signal light L1 and the local signal light L5.

The WSS 25I increases the optical power of the WDM light Lw output from the multiplexer 25G based on the control by the controller 25R, as in the case of the WSS 15E. For example, when the WDM light Lw obtained by multiplexing the remote signal light L1 and the local signal light L5 is input, the WSS 25I increases the optical power of the remote signal light L1 while maintaining the optical power of the local signal light L5 based on the control of the controller 15K. This reduces the amount of noise occurred in the transmission line 50 provided in the remote section relative to the remote signal light L1.

Since the optical power of the remote signal light L1 is increased while the optical power of the local signal light L5 is maintained, the optical power of the WDM light Lw is increased as a result. Therefore, the input power of the WDM light Lw input to the WDM amplifier 25K provided as a post amplifier in the subsequent stage of the WSS 25I increases. Thus, even if the WDM light Lw propagates through the transmission line 52 provided in the WDM transmission section, the noise occurred in the WDM transmission section is reduced as compared with the case where the optical power of the remote signal light L1 is not increased.

The WDM amplifier 25K is an optical amplifier including, for example, the EDFA. The WDM amplifier 25K receives the WDM light Lw and amplifies the WDM light Lw in the ALC mode. The WDM amplifier 25K amplifies the WDM light Lw and outputs the WDM light Lw to the transmission line 52.

The PD 25M is connected to an optical path, through which the WDM light Lw propagates, via a branch coupler 25S. Thus, the PD 25M can detect the optical power of the WDM light Lw. The branch coupler 25S is provided upstream or in front of the WDM amplifier 25K. Therefore, when the PD 25M detects the optical power of the WDM light Lw, the PD 25M can output the optical power of the WDM light Lw to the controller 25R as the amplifier input power of the WDM amplifier 25K.

The PD 25N is connected to an optical path, through which the WDM light Lw propagates, via a branch coupler 25T. Thus, the PD 25N can detect the optical power of the WDM light Lw. The branch coupler 25T is provided downstream or after the WDM amplifier 25K. Therefore, when the PD 25N detects the optical power of the WDM light Lw, the PD 25N can output the optical power of the WDM light Lw to the controller 25R as the amplifier output power of the WDM amplifier 25K.

The controller 25R is electrically connected to the optical transmitters 25A, . . . , and 25C, the optical receivers 25D, . . . , and 25F, the WSSs 25I, 25J, and the PDs 25M, 25N, 25P, and 25Q. The controller 25R can control operations of the optical transmitters 25A, . . . , and 25C and the WSSs 25I, 25J. For example, the controller 25R can independently control the optical transmitter 25C to transmit the local signal light L8 to the optical transmitter 25C. The controller 25R can control the WSSs 25I and 25J to change the slot widths of the WSSs 25I and 25J. The controller 25R can output the optical power of the WDM light Lw detected by the PDs 25M, 25N, 25P, and 25Q to the NMS 100 as the amplifier input power and the amplifier output power, respectively.

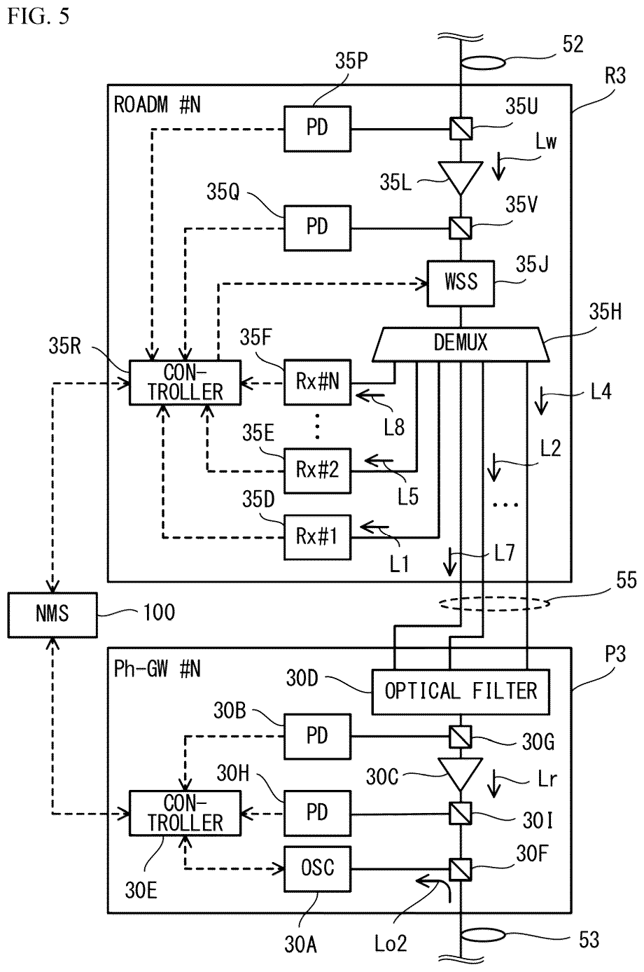

Next, referring to FIG. 5, the ROADM device R3 and the photonic gateway P3 will be described.

First, the ROADM device R3 will be described. The ROADM device R3 includes a plurality of optical receivers 35D, 35E, . . . , and 35F, a demultiplexer 35H, a WSS 35J, a WDM amplifier 35L, PDs 35P, 35Q, and a controller 35R.

The WDM amplifier 35L is an optical amplifier including, for example, the EDFA. The WDM amplifier 35L, as a preamplifier provided in the preceding stage of the WSS 35J, receives the WDM light Lw input to the ROADM device R3 and amplifies the WDM light Lw in the ALC mode. The WDM amplifier 35L amplifies the WDM light Lw and outputs the WDM light Lw to the downstream of the WDM amplifier 35L.

The PD 35P is connected to an optical path, through which the WDM light Lw propagates, via a branch coupler 35U. Thus, the PD 35P can detect the optical power of the WDM light Lw. The branch coupler 35U is provided upstream or in front of the WDM amplifier 35L. Therefore, when the PD 35P detects the optical power of the WDM light Lw, the PD 35P can output the optical power of the WDM light Lw to the controller 35R as an amplifier input power of the WDM amplifier 35L.

The PD 35Q is connected to an optical path, through which the WDM light Lw propagates, via a branch coupler 35V. Thus, the PD 35Q can detect the optical power of the WDM light Lw. The branch coupler 35V is provided downstream or in the subsequent stage of the WDM amplifier 35L. Therefore, when the PD 35Q detects the optical power of the WDM light Lw, the PD 35Q can output the optical power of the WDM light Lw to the controller 35R as the amplifier output power of the WDM amplifier 35L.

The WSS 35J increases the optical power of the WDM light Lw based on the control by the controller 35R, as in the case of the WSS 15E. For example, when the WDM light Lw obtained by multiplexing the remote signal light L1 and the local signal light L5 is input, the WSS 35J increases the optical power of the remote signal light L1 while maintaining the optical power of the local signal light L5 based on a control of the controller 35R. This reduces the amount of noise occurred in the transmission line 50 provided in the remote section relative to the remote signal light L1. Since the optical power of the remote signal light L1 is increased while the optical power of the local signal light L5 is maintained, the optical power of the WDM light Lw is increased as a result.

The demultiplexer 35H demultiplexes the WDM light Lw output from the WSS 35J into remote signal lights L1 and L2 and local signal lights L4, L5, L7, and L8. The demultiplexer 35H demultiplexes the WDM light Lw, and outputs, for example, the remote signal light L2 and the local signal lights L4 and L7 to the downstream of the demultiplexer 25H, and outputs the remote signal light L1 and the local signal lights L5 and L8 to the optical receivers 35D, 35E, . . . , and 35F.

The optical receiver 35D receives the remote signal light L1. The optical receiver 35D may receive the remote signal light L2. The optical receiver 35E receives the local signal light L5. The optical receiver 35E may receive the local signal light L4. The optical receiver 35F receives the local signal light L8. The optical receiver 35F may receive the local signal light L7. Optical receivers (not illustrated) other than the optical receivers 35D, 35E, . . . , and 35F also receive the remote signal light or the local signal light in the same manner as the optical receivers 35D, 35E, . . . , and 35F. The optical receivers 35D, 35E, . . . , and 35F, etc. convert the remote signal light L1 and the local signal lights L5, L8, etc. into electric digital signals. The controller 35R measures signal qualities of the remote signal light L1 and the local signal lights L5, L8, etc., based on the digital signals.

The controller 35R is electrically connected to the optical receivers 35D, 35E, . . . , and 35F, the WSS 35J, and the PDs 35P, 35Q. The controller 35R can control an operation of the WSS 35J. For example, the controller 35R can control the WSS 35J to change the slot width of the WSS 35J. The controller 35R can output the optical power of the WDM light Lw detected by the PDs 35P and 35Q to the NMS 100 as the amplifier input power and the amplifier output power, respectively.

Next, the photonic gateway P3 will be described. The photonic gateway P3 includes an OSC communicator 30A, PDs 30B and 30H, a transmission amplifier 30C, an optical filter 30D, and a controller 30E. The transmission amplifier 30C is an example of a second amplifier. In this embodiment, the photonic gateway P3 may not include the OSC communicator 30A.

The optical filter 30D includes an optical coupler such as a coupler for wavelength division multiplexing. Accordingly, when the remote signal light L2 and the local signal lights L4 and L7 are individually input to the optical filter 30D, the remote signal light L2 and the local signal lights L4 and L7 are multiplexed by the optical filter 30D, and the remote multiplexed light Lr is output from the optical filter 30D. For example, when the remote signal light L1 is input to the optical filter 30D alone, the remote signal light L1 is output from the optical filter 30D as the remote multiplexed light Lr.

The transmission amplifier 30C is an optical amplifier including, for example, the EDFA. The transmission amplifier 30C amplifies the remote multiplexed light Lr. When the transmission amplifier 30C amplifies the remote multiplexed light Lr, the transmission amplifier 30C outputs and transmits the remote multiplexed light Lr to the transmission line 53.

The PD 30B is connected to the optical path, through which the remote multiplexed light Lr propagates, via a branch coupler 30G. Thus, the PD 30B can detect the optical power of the remote multiplexed light Lr. The PD 30B is provided upstream or in front of the transmission amplifier 30C. Therefore, when the PD 30B detects the optical power of the remote multiplexed light Lr, the PD 30B can output the optical power of the remote multiplexed light Lr to the controller 30E as an amplifier input power of the transmission amplifier 30C.

The PD 30H is connected to the optical path, through which the remote multiplexed light Lr propagates, via a branch coupler 30I. Thus, the PD 30H can detect the optical power of the remote multiplexed light Lr. The PD 30H is provided downstream or in a subsequent stage of the transmission amplifier 30C. Therefore, when the PD 30H detects the optical power of the remote multiplexed light Lr, the PD 30H can output the optical power of the remote multiplexed light Lr to the controller 30E as an amplifier output power of the transmission amplifier 30C.

The OSC communicator 30A can receive the OSC light Lo2 propagated through the transmission line 53 via an OSC splitter 30F. As will be described in detail later, the OSC light Lo2 is output from the remote transponder RG.

The controller 30E is electrically connected to the OSC communicator 30A and the PDs 30B and 30H. For example, when the amplifier input power and the amplifier output power output from the PDs 30B and 30H are input, the controller 30E can output the amplifier input power and the amplifier output power to the NMS 100.

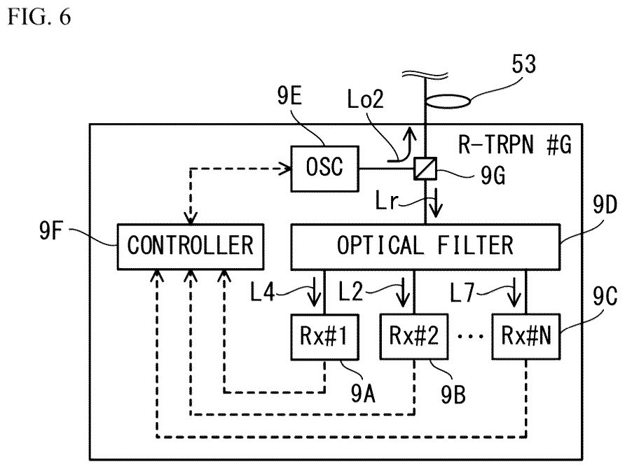

Next, referring to FIG. 6, the remote transponder RG will be described. The remote transponder RG includes a plurality of optical receivers 9A, 9B, . . . , and 9C, an optical filter 9D, an OSC communicator 9E, and a controller 9F. Although not illustrated, the remote transponder RG may include a plurality of optical transmitters.

The OSC communicator 9E transmits the OSC light Lo2 based on a control of the controller 9F. The OSC communicator 9E is connected to the optical path, through which the remote multiplexed light Lr propagates, via an OSC coupler 9G. As a result, the OSC light Lo2 is output from the remote transponder RG to the transmission line 53.

The optical filter 9D includes an optical coupler such as a coupler for wavelength division multiplexing. Therefore, when the remote multiplexed light Lr is input to the optical filter 9D, the remote multiplexed light Lr is demultiplexed by the optical filter 9D, and the remote signal light L2 and the local signal lights L4 and L7 are output from the optical filter 9D.

The optical receiver 9A receives the local signal light L4 output from the optical filter 9D. The optical receiver 9B receives the remote signal light L2 output from the optical filter 9D. The optical receiver 9C receives the local signal light L7 output from the optical filter 9D. Optical receivers (not illustrated) other than the optical receivers 9A, 9B, and 9C also receive the remote signal light in the same manner as the optical receivers 9A, 9B, and 9C. The optical receivers 9A, 9B, 9C, etc. convert the remote signal light L2 and the local signal light L7, L8, etc. into electric digital signals.

The controller 9F is electrically connected to the optical receivers 9A, 9B, . . . , and 9C and the OSC communicator 9E. The controller 9F can control an operation of the OSC communicator 9E. For example, the controller 9F can control the OSC communicator 9E to transmit the OSC light Lo2 to the OSC communicator 9E. The controller 9F measures signal qualities of the remote signal light L2 and the local signal lights L4, L7, etc., based on the digital signals converted by the optical receivers 9A, 9B, and 9C.

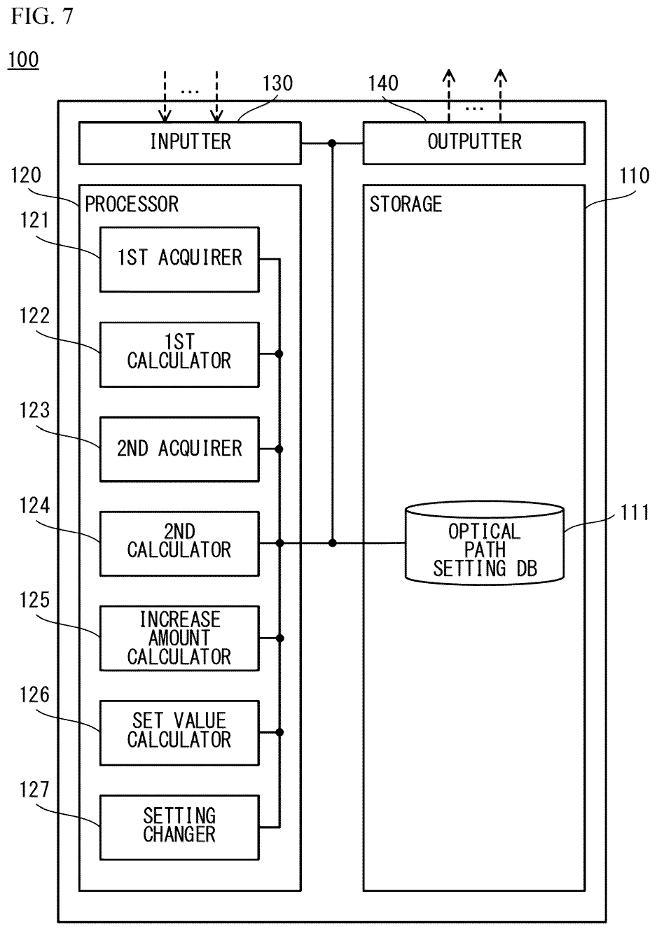

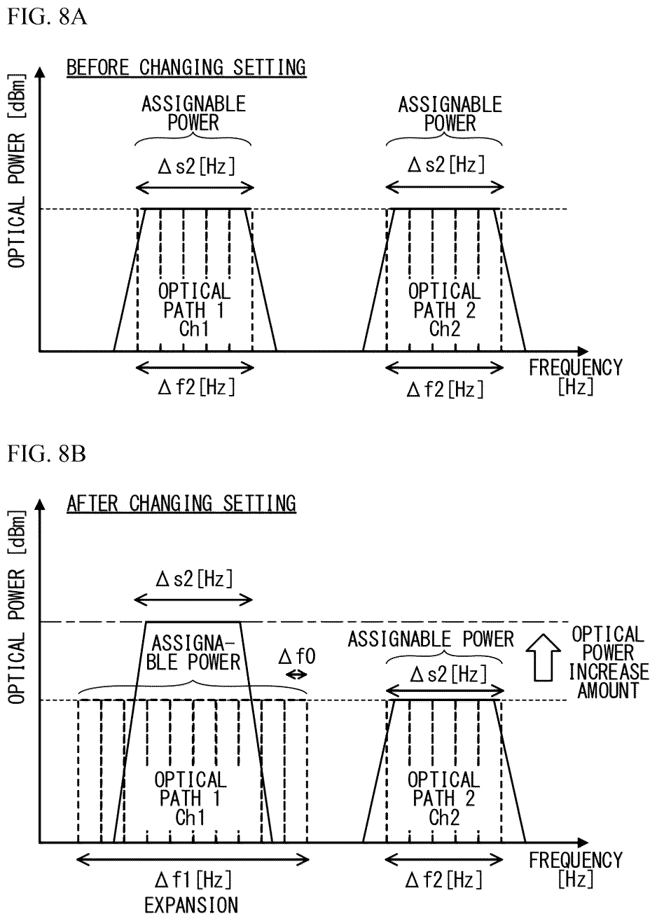

Referring to FIGS. 7, 8A and 8B, the functional configuration of the NMS 100 will be described together with the hardware configuration. The above-described controllers 5F, 9F, 10E, 15K, 25R, 30E, and 35R have basically the same hardware configuration as that of the NMS 100, and therefore, detailed description thereof will be omitted.

The NMS 100 is implemented by, for example, a processor such as a central processing unit (CPU) and a memory such as a random-access memory (RAM) or a read only memory (ROM). The RAM temporarily stores a control program stored in the ROM by the CPU. The CPU executes the stored control program to realize various functions described later. The control program may be one corresponding to a flowchart described later. The NMS 100 may be implemented by a hardware circuit such as a field programmable gate array (FPGA) or an application specific integrated circuit (ASIC).

As illustrated in FIG. 7, the NMS 100 includes a storage 110, a processor 120, an inputter 130, and an outputter 140. The storage 110 can be realized by the above-described memory. The processor 120 can be realized by the above-described processor. The inputter 130 and the outputter 140 can be realized by a communication interface (I/F).

The storage 110, the processor 120, the inputter 130, and the outputter 140 are connected to each other. The storage 110 includes an optical path setting database (DB) 111. The processor 120 includes a first acquirer 121, a first calculator 122, a second acquirer 123, a second calculator 124, an increase amount calculator 125, a set value calculator 126, and a setting changer 127. The first acquirer 121 and the second acquirer 123 are examples of the acquirers. The first calculator 122, the second calculator 124, the increase amount calculator 125, and the set value calculator 126 are examples of the calculators.

The optical path setting DB 111 stores calculation basic information used when calculating the noise amount of noise occurred in the remote section or the WDM transmission section. The basic calculation information includes, for example, remote determination information indicating whether or not the optical path includes the remote section, information indicating a basic control target value of the optical power of the signal light selectable according to a symbol rate, and information relating to a basic slot width determined from the symbol rate. The basic calculation information includes a noise coefficient (so-called noise figure) of the optical amplifier, a nonlinear noise coefficient selectable according to the type of the optical fiber included in the transmission lines 50, 51, 52, and 53, and the like.

The first acquirer 121 acquires power information of the remote section from the controller 10E of the photonic gateway P1 and the controller 30E of the photonic gateway P3. The power information indicates the transmission state. For example, the first acquirer 121 acquires the transmitter output power described above and the amplifier input power of the reception amplifier 10C from the controller 10E as power information of the remote section. The first acquirer 121 acquires the amplifier input power and the amplifier output power of the transmission amplifier 30C from the controller 30E as the power information of the remote section.

The first calculator 122 calculates the amount of noise occurred in the remote section based on the power information of the remote section. More specifically, the first calculator 122 calculates the noise amount Noise/Signal_{Remote} of the optical path including the remote section based on the power information of the remote section and, for example, the following formula (1).

$$\begin{matrix}Noise / {Signal}_{Remote} = 1 / {GSNR}_{Remote} \\ = 1 / {GSNR}_{Remote ( 1 )} + 1 / {GSNR}_{Remote ( 2 )}\end{matrix} \qquad [ Formula ( 1 ) ]$$

Here, 1/GSNR_{REMOTE(1)} in the above-mentioned formula (1) can be expressed by the following formula (2). The 1/GSNR_{REMOTE(2)} in the above formula (1) can be expressed by the following formula (3).

$$1 / {GSNR}_{Remote ( 1 )} = 1 / {SNR}_{ASE ( 1 )} + 1 / {SNR}_{NLI ( 1 )} \qquad [ Formula ( 2 ) ]$$

$$1 / {GSNR}_{Remote ( 2 )} = 1 / {SNR}_{ASE ( 2 )} + 1 / {SNR}_{NLI ( 2 )} \qquad [ Formula ( 3 ) ]$$

Furthermore, 1/SNR_{ASE(1)} in the above-mentioned formula (2) can be expressed by the following formula (4). The 1/SNR_{NLI(1)} in the above formula (2) can be expressed by the following formula (5). The first calculator 122 can acquire the amplifier noise coefficient NF_{Amp} of the reception amplifier 10C and the nonlinear noise coefficient n of the transmission line 50 from the optical path setting DB111. P_{AmpIn} represents the amplifier input power of the reception amplifier 10C. h represents Planck's constant. v represents a signal frequency of the signal light. Δf represents the frequency bandwidth. The same applies to h, v, and Δf in the following formulas. P²ᵢₙ represents the transmitter output power.

$${SNR}_{ASE ( 1 )} = \frac{{P}_{AmpIn}}{{NF}_{Amp} \cdot hv Δ f} \qquad [ Formula ( 4 ) ]$$

$${SNR}_{NLI ( 1 )} = \frac{1}{η \cdot {P}_{in}^{2}} \qquad [ Formula ( 5 ) ]$$

On the other hand, 1/SNR_{ASE(2)} in the above-mentioned formula (3) can be expressed by the following formula (6). The 1/SNR_{NLI(2)} in the above formula (3) can be expressed by the following formula (7). The first calculator 122 can acquire the amplifier noise coefficient NF Amp of the transmission amplifier 30C and the nonlinear noise coefficient n of the transmission line 53 from the optical path setting DB111. P_{AmpIn} represents the amplifier input power of the transmission amplifier 30C. P²ᵢₙ represents the amplifier output power of the transmission amplifier 30C.

$${SNR}_{ASE ( 2 )} = \frac{{P}_{AmpIn}}{{NF}_{Amp} \cdot hv Δ f} \qquad [ Formula ( 6 ) ]$$

$${SNR}_{NLI ( 2 )} = \frac{1}{η \cdot {P}_{i n}^{2}} \qquad [ Formula ( 7 ) ]$$

By calculating the amount of noise Noise/Signal_{Remote} occurred in the remote section in this way, the first calculator 122 can calculate a specific transmission characteristic representing the transmission characteristic of the optical path including the remote section.

The second acquirer 123 acquires power information of the WDM transmission section from the controller 15K of the ROADM device R1, the controller 25R of the ROADM device R2, and the controller 35R of the ROADM device R3. For example, the second acquirer 123 acquires the amplifier input power and the amplifier output power of the WDM amplifier 15F from the controller 15K as the power information of the WDM transmission section. The second acquirer 123 acquires the amplifier input power and the amplifier output power of each of the WDM amplifiers 25K and 25L from the controller 25R as the power information of the WDM transmission section. Further, the second acquirer 123 acquires the amplifier input power and the amplifier output power of the WDM amplifier 35L from the controller 35R as the power information of the WDM transmission section.

The second calculator 124 calculates the amount of noise occurred in the WDM transmission section based on the power information of the WDM transmission section. More specifically, the second calculator 124 calculates the noise amount Noise/Signal WDM of the optical path including the WDM transmission section based on the power information of the WDM transmission section and, for example, the following formula (8).

$$Noise / {Signal}_{WDM} = 1 / {GSNR}_{WDM} = {\sum }_{í = 1}^{N} 1 / GSN {R}_{WDM ( i )} \qquad [ Formula ( 8 ) ]$$

Here, 1/GSNR_{WDM (i)} in the above-mentioned formula (8) can be expressed by the following formula (9). Note that WDM (i) represents the amount of noise in the i-th (i is a natural number) WDM transmission section. For example, the first WDM transmission section corresponds to the transmission section of the transmission line 51.

$$1 / {GSNR}_{WDM ( i )} = 1 / {SNR}_{ASE ( ì - 1 )} + 1 / {SNR}_{ASE ( i - 2 )} + 1 / {SNR}_{NLI ( i )} \qquad [ Formula ( 9 ) ]$$

Furthermore, 1/SNR_{ASE(i-1)} in the above-described formula (9) can be expressed by the following formula (10). ASE (i−1) represents amplified spontaneous emission light of a WDM amplifier that transmits a WDM light to a transmission line corresponding to the i-th WDM transmission section. The 1/SNR_{ASE(i-2)} in the above formula (9) can be expressed by the following formula (11). ASE (i−2) represents amplified spontaneous emission light of a WDM amplifier that receives WDM light from a transmission line corresponding to the i-th WDM transmission section. The 1/SNR_{NLI(i)} in the above formula (9) can be expressed by the following formula (12). NLI(i) represents nonlinear interference in a transmission line corresponding to the i-th WDM transmission section. The second calculator 124 can acquire the amplifier noise coefficient NF_{Amp} of the WDM amplifiers 15F, 25K, etc, and the nonlinear noise coefficient η of the transmission line 50 from the optical path setting DB111.

$${SNR}_{ASE ( i - 1 )} = \frac{{P}_{AmpIn}}{{NF}_{Amp} \cdot hv Δ f} \qquad [ Formula ( 10 ) ]$$

$${SNR}_{ASE ( i - 2 )} = \frac{{P}_{AmpIn}}{{NF}_{Amp} \cdot hv Δ f} \qquad [ Formula ( 11 ) ]$$

$${SNR}_{NLI ( i )} = \frac{1}{η \cdot {P}_{i n}^{2}} \qquad [ Formula ( 12 ) ]$$

By calculating the amount of noise Noise/Signal WDM occurred in the WDM transmission section in this way, the second calculator 124 can calculate a specific transmission characteristic representing a transmission characteristic of the optical path including the WDM transmission section.

The increase amount calculator 125 calculates an increase amount of optical power of the WDM light Lw in the WDM transmission section. The increase amount calculator 125 calculates the optical power increase amount ΔPowertarget based on, for example, the two noise amounts Noise/Signal_{Remote} and Noise/Signal_{WDM} described above and the following formula (13). The increase amount calculator 125 can acquire the basic control target value Powertarget_{Base} of the optical power from the optical path setting DB111.

$$Δ Powertarget = \frac{{Powertaget}_{Base}}{\frac{Noise / {Signal}_{WDM}}{Noíse / {Signal}_{Remote}} - 1} \qquad [ Formula ( 13 ) ]$$

The set value calculator 126 calculates signal slot width set values to be set in the ROADM devices R1, R2, . . . , and R3. That is, the set value calculator 126 calculates signal slot width set values to be set for the WSSs 15E, 25I, 25J, 35J, etc. The signal slot width set value SlotWidth calculated by the set value calculator 126 can be expressed by the following formula (14).

$$SlotWidth = {SlotWídth}_{Base} + Δ SlotWidth \qquad [ Formula ( 14 ) ]$$

The signal slot difference Δ SlotWidth in the formula (14) can be expressed by the following formula (15). Therefore, the formula (14) can be expressed by the following formula (16).

$$Δ SlotWidth = \frac{Δ Powertarget}{Power {target}_{Base}} \cdot {SlotWídth}_{Base} \qquad [ Formula ( 15 ) ]$$

$$SlotWidth = {SlotWidth}_{Base} \cdot ( 1 + \frac{Δ Powertarget}{{Powertarget}_{Base}} ) \qquad [ Formula ( 16 ) ]$$

Thus, the set value calculator 126 can calculate the signal slot width set value SlotWidth based on the basic slot width SlotWidth_{Base}, the optical power increase Δ Powertarget, the control target value Powertarget_{Base}, and formula (16). The setting value calculator 126 can acquire the slot width SlotWidth_{Base} and the control target value Powertarget_{Base} from the optical path setting DB111.

The setting changer 127 sets the signal slot width setting value SlotWidth calculated by the setting value calculator 126 in the ROADM devices R1, R2, R3, etc., and changes the setting of the ROADM devices R1, R2, R3, etc. More specifically, the set value calculator 126 sets the signal slot width set value SlotWidth to the WSS 15E, 25I, 25J, 35J, etc., and changes the settings of the WSS 15E, 25I, 25J, 35J, etc.

As a result, as illustrated in FIGS. 8A and 8B, assignable power changes before and after the setting change. Channel Ch1 represents, for example, a frequency band (or a wavelength band) of the remote signal light L1 allocated to the optical path 1 accommodated in the optical network NW. Channel Ch2 represents, for example, a frequency band (or a wavelength band) of the local signal light L5 allocated to the optical path 2 accommodated in the optical network NW.

Here, the optical power increase amount ΔPowertarget is calculated before the signal slot width set value SlotWidth is calculated. That is, as illustrated in FIGS. 8A and 8B, the optical power increase amount ΔPowertarget is determined before the signal slot width set value SlotWidth. After the optical power increase ΔPowertarget is determined, the signal slot width set value SlotWidth to be realized by controlling an attenuation amount of the WSS15E or the like is determined. Thus, the signal slot width Δf2 in the channel Ch1 is increased to the signal slot width Δf1 before and after the setting change while the signal spectrum widths Δs1 and Δs2 are maintained.

Here, each of the WSSs 15E, 25I, 25J, and 35J controls the optical power per unit frequency Δf0 to be constant, which minimizes a nonlinear effect (specifically, noise), regardless of the symbol rate. Therefore, the assignable power is obtained by multiplying the optical power per unit frequency Δf0 by the number N of unit frequencies Δf0. That is, the signal slot widths Δf1 and Δf2 are both determined by the unit frequency Δf0×N. In this way, the signal slot width Δf2 is increased to the signal slot width Δf1, and the assignable power is increased, so that the optical power of the WDM light Lw including the remote signal light L1 is increased. This suppresses a decrease in transmission performance and makes it possible to extend the transmission distance.

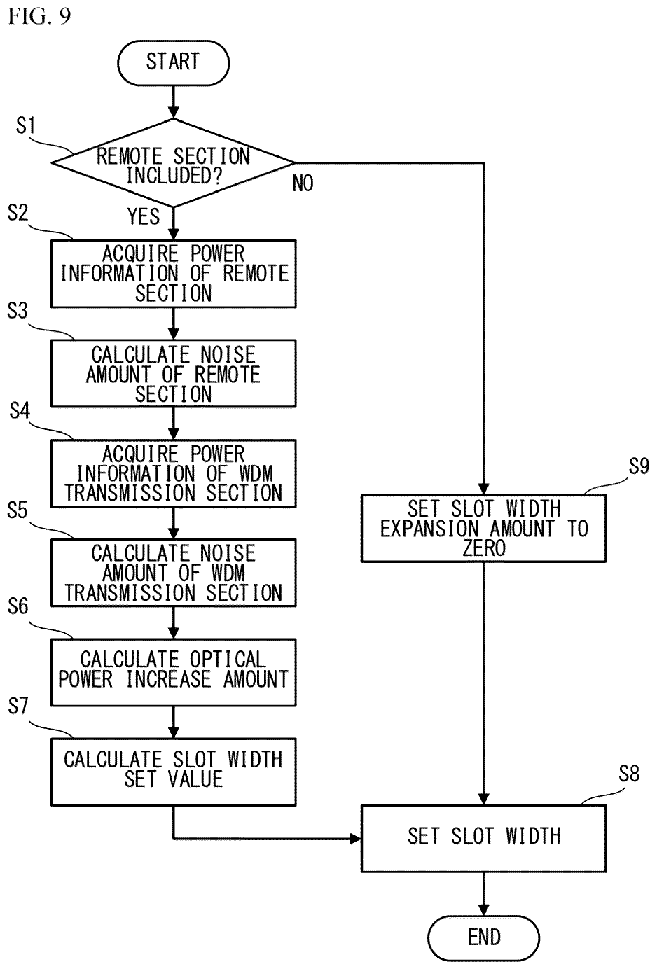

Referring to FIG. 9, the operation of the NMS 100 will be described.

First, the increase amount calculator 125 determines whether or not the optical path accommodated in the optical network NW includes the remote section (step S1). The increase amount calculator 125 can determine whether or not the remote section is included by acquiring the remote determination information from the optical path setting DB111.

When the optical path includes the remote section (step S1: YES), the first acquirer 121 acquires the power information of the remote section (step S2). When the first acquirer 121 acquires the power information of the remote section, the first calculator 122 calculates the noise amount of the remote section (step S3). As described above, the first calculator 122 can calculate the amount of noise occurred in the remote section based on the power information of the remote section.

When the first calculator 122 calculates the amount of noise in the remote section, the second acquirer 123 acquires the power information of the WDM transmission section (step S4). When the second acquirer 123 acquires the power information of the WDM transmission section, the second calculator 124 calculates the amount of noise in the WDM transmission section (step S5). As described above, the second calculator 124 can calculate the amount of noise occurred in the WDM transmission section based on the power information of the WDM transmission section.

When the second calculator 124 calculates the amount of noise in the WDM transmission section, the increase amount calculator 125 calculates the optical power increase amount (step S6). The increase amount calculator 125 can calculate the optical power increase amount based on the two noise amounts calculated in the steps S3 and S5. When the increase amount calculator 125 calculates the optical power increase amount, the set value calculator 126 calculates a slot width set value (step S7). The set value calculator 126 can calculate the slot width set value based on the optical power increase amount calculated in step S6.

When the set value calculator 126 calculates the slot width set value, the setting changer 127 sets the slot width (step S8). That is, the setting changer 127 changes the setting of the ROADM devices R1, R2, R3, etc., based on the slot width setting value calculated by the set value calculator 126. When the setting changer 127 sets the slot width, the NMS 100 ends the processes.

In the processing of the step S1, when the optical path does not include the remote section (step S1: NO), the set value calculator 126 sets the slot width expansion amount to zero (step S9). When the setting value calculator 126 sets the slot width enlargement amount to zero, the setting changer 127 executes the processing of the step S8. Thus, when the optical path does not include the remote section, the slot width before the setting change is maintained. When the setting changer 127 executes the processing of the step S8, the NMS 100 ends the processes.

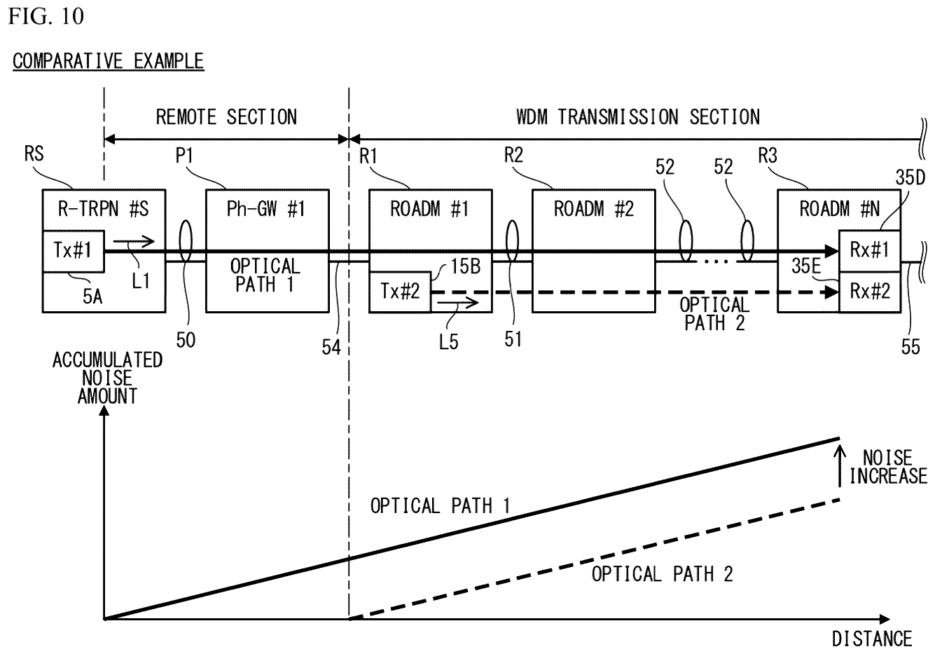

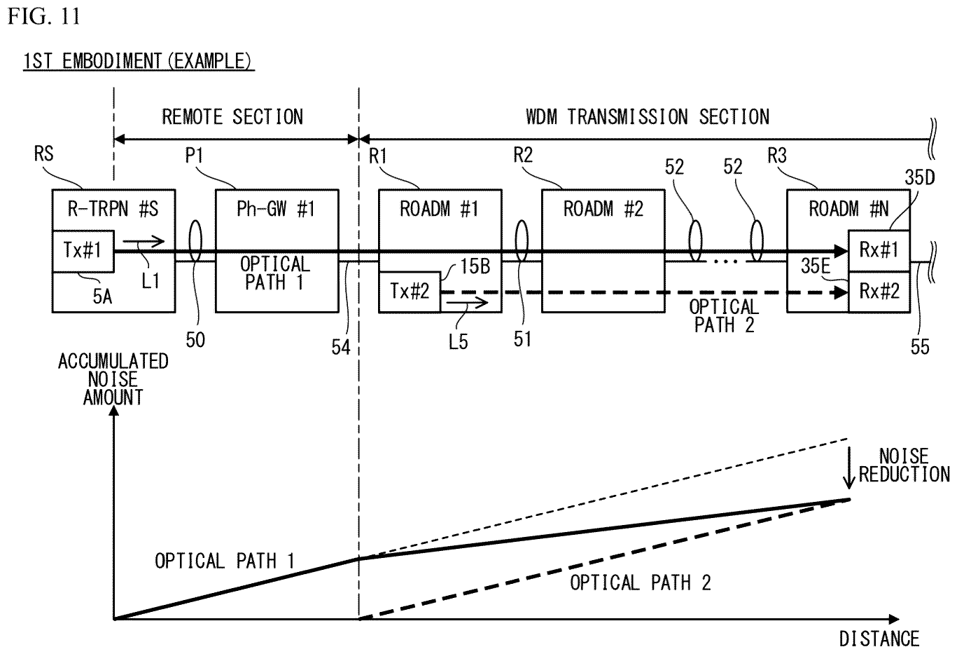

Referring to FIGS. 10 and 11, the effect of the present matter will be described in comparison with the comparative example.

First, in the comparative example, as illustrated in FIG. 10, in the case of the optical path 1 including the remote section, accumulated noise amount increases by the amount of the remote section as compared with the optical path 2 not including the remote section. In this way, the accumulated noise amount differs depending on the presence or absence of the remote section. The increase of the accumulated noise amount leads to the degradation of the transmission performance. Therefore, the transmission performance of the optical path 1 is degraded compared with the transmission performance of the optical path 2. Therefore, when there is the remote section, it becomes difficult to extend the transmission distance.

On the other hand, in the embodiment, as illustrated in FIG. 11, in the case of the optical path 1 including the remote section, the accumulated noise amount increases by the amount of the remote section as compared with the optical path 2 not including the remote section. However, in the WDM transmission section, the increase rate of the accumulated noise amount is reduced by changing the setting of the ROADM devices R1, R2, R3, etc. Thus, in the ROADM device R3, the accumulated noise amount of the optical path 1 is reduced equivalently to the accumulated noise amount of the optical path 2. As a result, the optical path 1 and the optical path 2 can obtain the same level of transmission performance. Therefore, even when there is a remote section, the transmission distance can be extended.

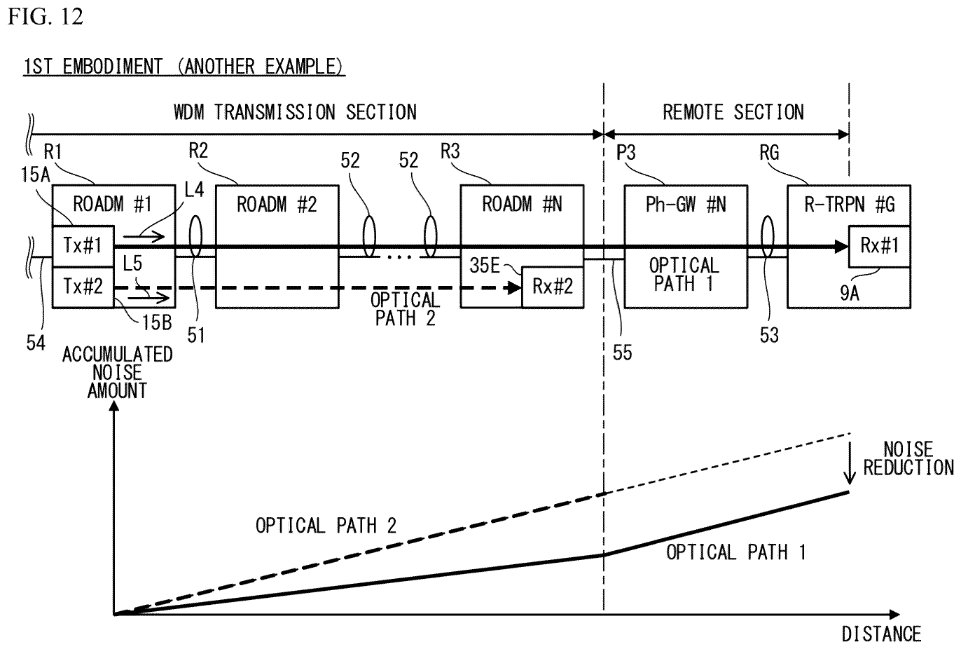

As another embodiment, as illustrated in FIG. 12, even when the remote section is on the receiving side, the accumulated noise amount is reduced as in the case where the remote section is on the transmitting side described with reference to FIG. 11. Therefore, even when the remote section is located on the receiving side, the transmission distance can be extended as in the case where the remote section is located on the transmitting side.

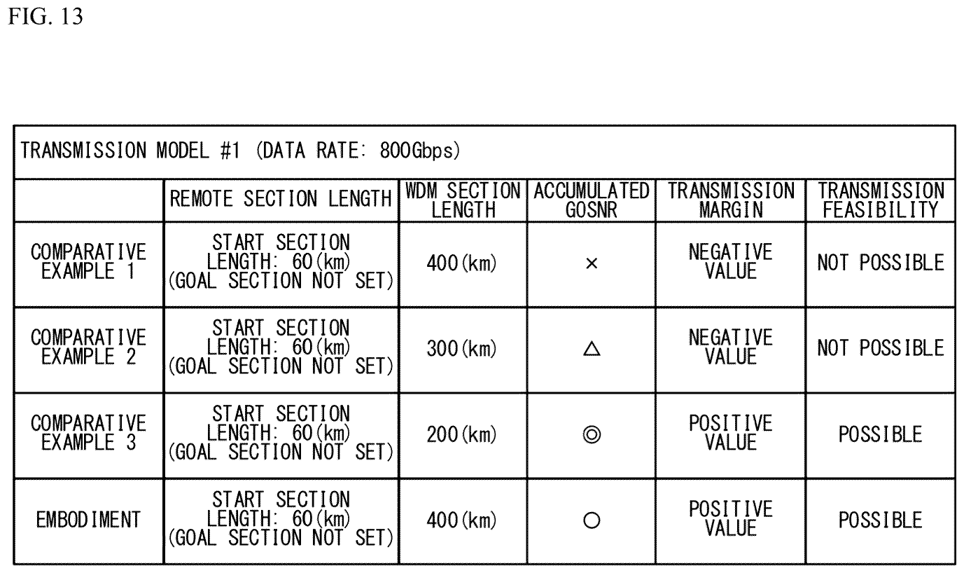

Referring to FIGS. 13 to 15, the effect of the present matter based on the difference in the transmission model will be described in comparison with a plurality of comparative examples.

First, as illustrated in FIG. 13, in a first transmission model #1, 800 Gbps is adopted as the data rate. The first transmission model #1 corresponds to cases described with reference to FIGS. 10 and 11. In the comparative examples 1 to 3 corresponding to FIG. 10 and the embodiment corresponding to FIG. 11, 60 km is adopted as the start section length representing the section length of the remote section (transmission side).

As illustrated in FIG. 13, in the comparative examples 1 and 2, a accumulated generalized optical signal to noise ratio (GOSNR) is relatively small in the comparative example 3 and the embodiment. Therefore, a negative value is recorded as a transmission margin, and it is difficult to realize transmission. On the other hand, in the comparative example 3 and the embodiment, the accumulated GOSNR is relatively large as in the comparative examples 1 and 2. Therefore, a positive value is recorded as the transmission margin, which ensures the realization of transmission. In particular, in the embodiment, the effect of extending the transmission distance in the WDM transmission section (indicated as the WDM section in FIGS. 13 to 15) is recognized as compared with the comparative example 3.

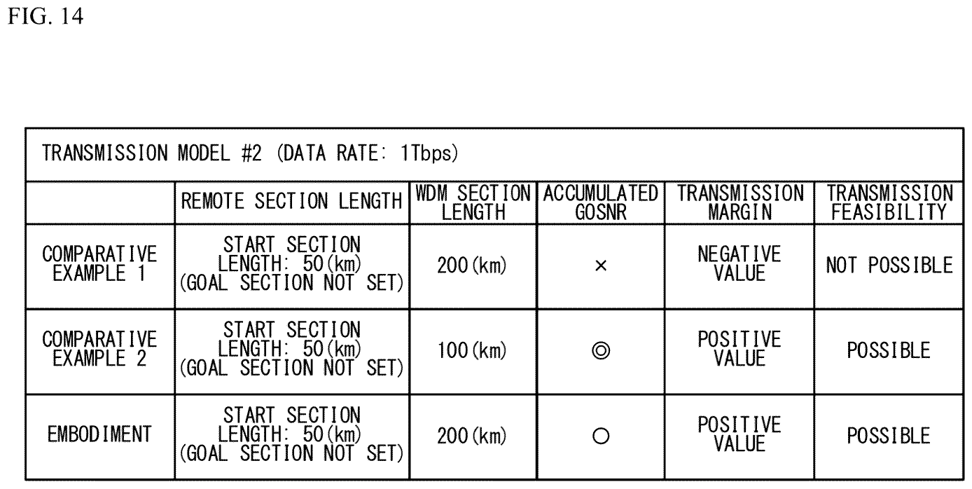

Next, as illustrated in FIG. 14, in a second transmission model #2, 1 Tbps is adopted as the data rate. The embodiment in the second transmission model #2 corresponds to a case described with reference to FIG. 12. Although not illustrated, the comparative examples 1 and 2 in the second transmission model #2 correspond to the case where the setting is not changed in the configuration of FIG. 12. In the comparative examples 1 and 2 and the embodiment, 50 km is adopted as the start section length representing the section length of the remote section (transmission side).

As illustrated in FIG. 14, in the comparative example 1, the accumulated GOSNR is relatively small in the comparative example 2 and the embodiment. Therefore, the negative value is recorded as a transmission margin, and it is difficult to realize transmission. On the other hand, in the comparative example 2 and the embodiment, the accumulated GOSNR is relatively large as compared with the comparative example 1. Therefore, the positive value is recorded as the transmission margin, which ensures the realization of transmission. In particular, in the embodiment, the effect of extending the transmission distance in the WDM transmission section is recognized as compared with the comparative example 2.

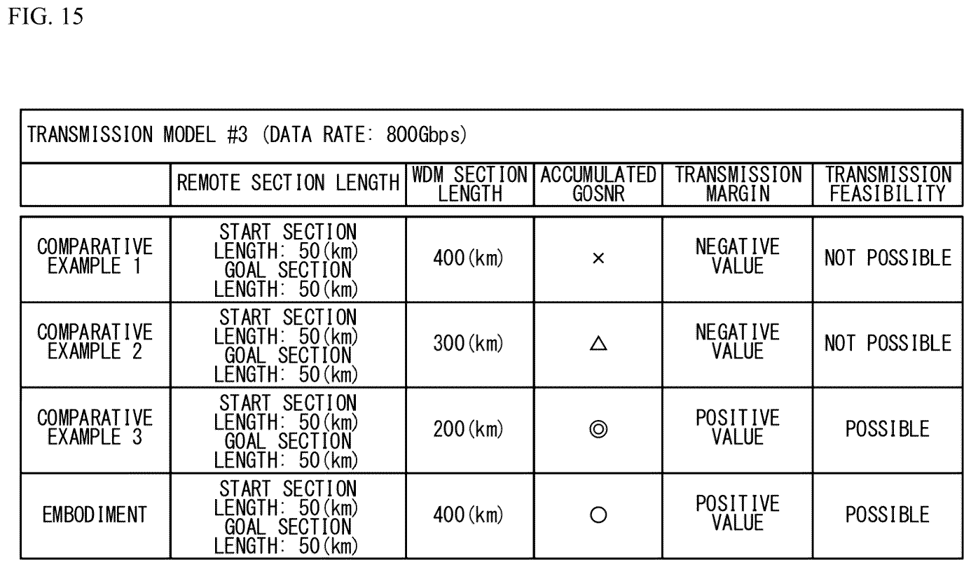

Next, as illustrated in FIG. 15, in a third transmission model #3, 800 Gbps is adopted as the data rate. The embodiment in the third transmission model #3 corresponds to a case where the setting is changed in the configuration of FIG. 1. The comparative examples 1 to 3 in the third transmission model #3 correspond to cases where the setting is not changed in the configuration of FIG. 1. In the comparative examples 1 to 3 and the embodiment, 50 km is adopted as the start section length representing the section length of the remote section (transmission side). In the comparative examples 1 to 3 and the embodiment, a goal section length of 50 km is adopted as a section length of the remote section (reception side).

As illustrated in FIG. 15, in the comparative examples 1 and 2, the accumulated GOSNR is relatively small in the comparative example 3 and the embodiment. Therefore, the negative value is recorded as the transmission margin, and it is difficult to realize transmission. On the other hand, in the comparative example 3 and the embodiment, the accumulated GOSNR is relatively large as in the comparative examples 1 and 2. Therefore, the positive value is recorded as the transmission margin, which ensures the realization of transmission. In particular, in the embodiment, the effect of extending the transmission distance in the WDM transmission section is recognized as compared with the comparison example 3.

### Second Embodiment

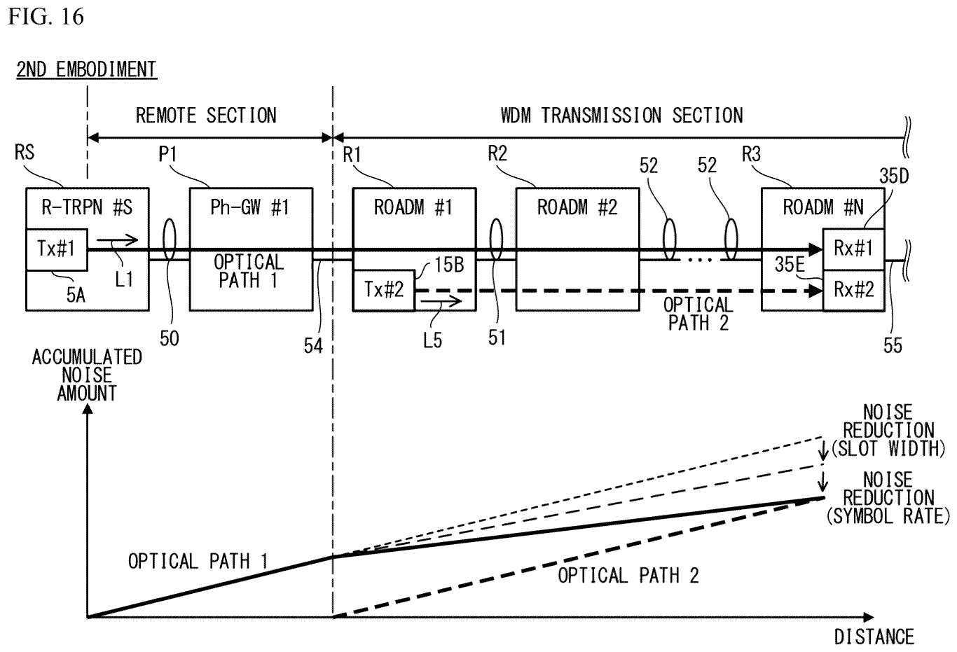

Referring to FIG. 16, the second embodiment of the present matter will be described. In the first embodiment, the setting change for increasing the slot width has been described as an example, but enlargement amount in the slot width may be limited depending on an accommodation status of the optical paths 1, 2, etc. accommodated in the optical network NW. If the enlargement amount is limited, there is a possibility that the noise amount cannot be sufficiently reduced.

In such a case, the NMS 100 may increase the symbol rate of the optical transmitter 5A, for example, in addition to the enlargement of the slot width. For example, the NMS 100 notifies the controller 10E of the photonic gateway P1 of a transmission request of the OSC light Lo1 including an instruction to increase the symbol rate of the optical transmitter 5A. The controller 10E controls the OSC communicator 10A based on the transmission request. Thus, the OSC communicator 10A transmits the OSC light Lo1 including an instruction to increase the symbol rate of the optical transmitter 5A.

The OSC communicator 5E of the remote transponder RS can receive the OSC light Lo1. Therefore, when the OSC communicator 5E receives the OSC light Lo1, the OSC communicator 5E notifies the controller 5F of the instruction to increase the symbol rate of the optical transmitter 5A. Thus, the controller 5F can increase the symbol rate of the optical transmitter 5A. Even if the noise amount cannot be sufficiently reduced due to the limitation of the expansion amount of the slot width, the accumulated noise amount of the optical path 1 is reduced equivalently to the accumulated noise amount of the optical path 2 by increasing the symbol rate, as illustrated in FIG. 16.

### Third Embodiment

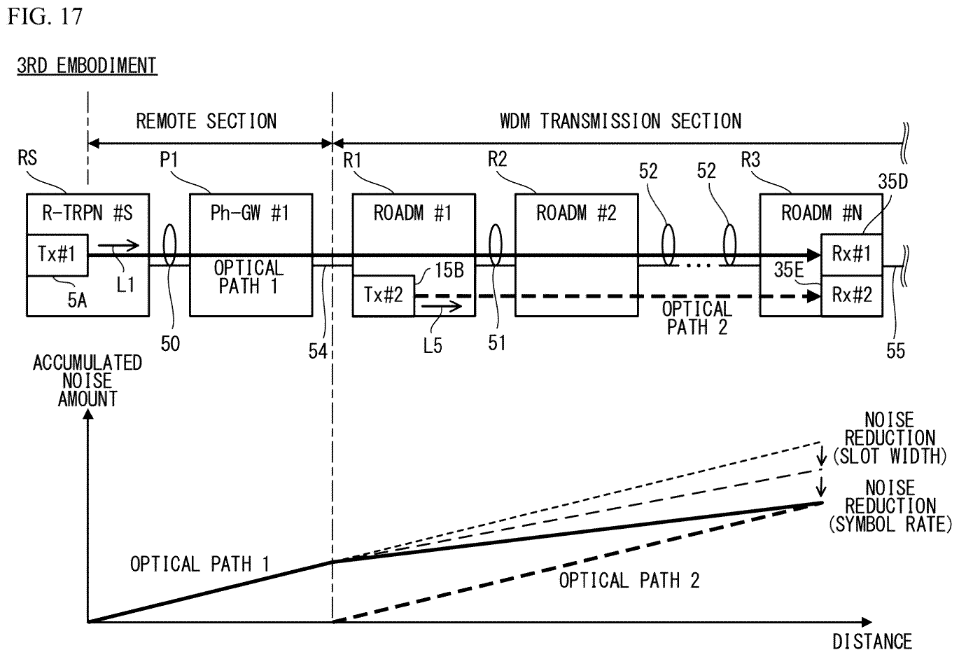

Referring to FIG. 17, the third embodiment of the present matter will be described. As described in the second embodiment, the enlargement amount of the slot width may be limited depending on the accommodation status of the optical paths 1, 2, etc. accommodated in the optical network NW.

In such a case, the NMS 100 may allocate the ROADM devices R1, R2, R3, etc. to a channel with small noise in the WDM transmission section in addition to the enlargement of the slot width. Even if the noise amount cannot be sufficiently reduced due to the limitation of the enlargement amount of the slot width, the accumulated noise amount of the optical path 1 is reduced equivalently to the accumulated noise amount of the optical path 2 by performing the allocation to the channel with small noise, as illustrated in FIG. 17.

### Fourth Embodiment

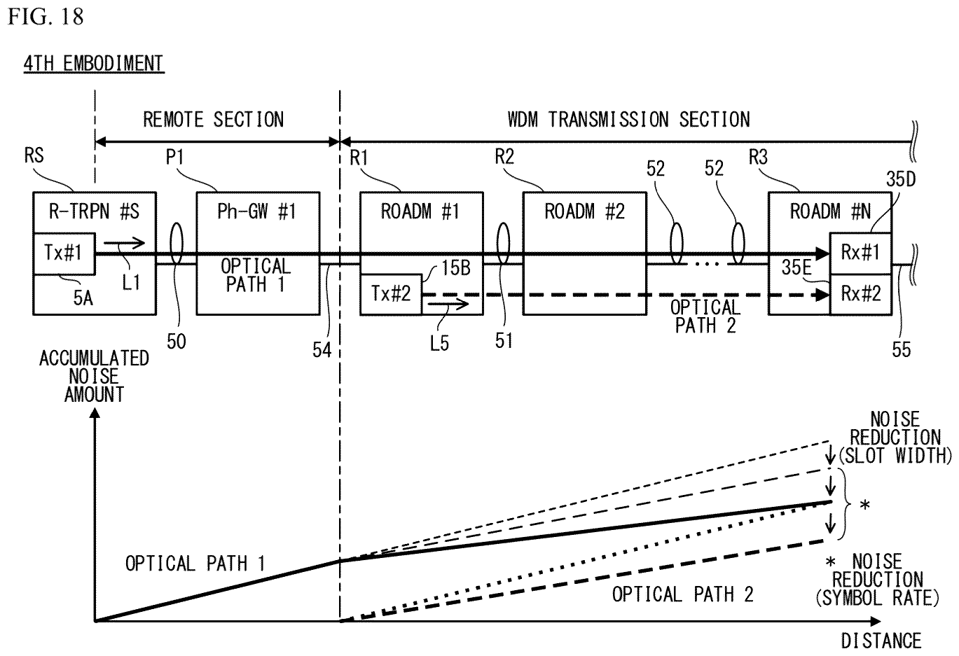

Referring to FIG. 18, the fourth embodiment of the present matter will be described. As described in the second embodiment, the enlargement amount of the slot width may be limited depending on the accommodation status of the optical paths 1, 2, etc. accommodated in the optical network NW.

In such a case, the NMS 100 may request the ROADM devices R1, R2, and R3 to reduce the attenuation amount of the WSSs 15E, 25I, 25J, and 35J in the WDM transmission section in addition to the enlargement of the slot width. In the WSSs 15E, 25I, 25J, and 35J, when the attenuation amount decreases, the optical power of the channel to be attenuated increases from the optical power before the attenuation is performed, and the noise amount decreases. On the other hand, the optical power of the channel not to be attenuated is reduced by the ALC from the optical power before the attenuation is performed, and the noise amount is increased. As a result, as illustrated in FIG. 18, the accumulated noise amount of the optical path 1 corresponding to the channel to be attenuated is reduced equivalently to the accumulated noise amount of the optical path 2 corresponding to the channel not to be attenuated.

Although the preferred embodiments of the present invention have been described in detail, the present invention is not limited to the specific embodiments, and various modifications and changes are possible within the scope of the gist of the present invention described in the claims. For example, although the first calculator 122 and the second calculator 124 respectively calculate the noise amount, decrease amount in the signal quality of the remote signal light L1 in the remote section may be calculated instead of the noise amount. The signal quality may be any of SNR, GSNR, OSNR, and GOSNR. In the above embodiment, the NMS 100 controls the operations of the ROADM devices R1, R2, . . . , and R3 and the operation of the remote transponder RS, but the NMS 100 may control the operations of the photonic gateways P1, P3. In this case, the WSS may be provided in the preceding stage or the subsequent stage of the reception amplifier 10C or the transmission amplifier 30C.

What is claimed is:

1. A network control device for controlling a plurality of devices included in an optical network, comprising:
an acquirer that acquires first information indicating a transmission state of each of an optical transmission and reception device, a first wavelength division multiplexing device connected to the optical transmission and reception device via a first transmission line, and a second wavelength division multiplexing device connected to the first wavelength division multiplexing device via a second transmission line different from the first transmission line from at least one of the optical transmission and reception device, the first wavelength division multiplexing device, and the second wavelength division multiplexing device;
a calculator that calculates transmission performance in the first transmission line based on the first information; and
a setting changer that changes a setting of at least one of the optical transmission and reception device, the first wavelength division multiplexing device, and the second wavelength division multiplexing device based on the transmission performance in the first transmission line.

2. The network control device according to claim 1, wherein
the optical transmission and reception device includes an optical transmitter that transmits a signal light,
the first wavelength division multiplexing device includes a first amplifier that receives and amplifies the signal light from the optical transmission and reception device,
the acquirer acquires output power of the optical transmission and reception device and input power of the signal light for the first amplifier as the first information,
the calculator calculates the transmission performance in the first transmission line based on the first information, and
the setting changer changes the setting of at least one of the optical transmission and reception device and the first wavelength division multiplexing device based on the transmission performance in the first transmission line.

3. The network control device according to claim 1, wherein
the first wavelength division multiplexing device includes a second amplifier that amplifies and transmits the signal light,
the optical transmission and reception device includes an optical receiver that receives the signal light from the first wavelength division multiplexing device,
the acquirer acquires input power of the signal light for the second amplifier and output power of the signal light from the second amplifier as the first information,
the calculator calculates the transmission performance in the first transmission line based on the first information, and
the setting changer changes the setting of at least one of the first wavelength division multiplexing device and the second wavelength division multiplexing device based on the transmission performance in the first transmission line.

4. The network control device according to claim 1, wherein
the setting changer changes the setting of the second wavelength division multiplexing device for the signal light of a channel relating to the transmission performance in the first transmission line to a setting for increasing the output power of the second wavelength division multiplexing device based on the transmission performance in the first transmission line.

5. The network control device according to claim 1, wherein
the second wavelength division multiplexing device includes a wavelength selection switch that outputs a signal light to a downstream optical amplifier, and
the setting changer changes a setting of the wavelength selection switch for the signal light of a channel relating to the transmission performance in the first transmission line to a setting for increasing the output power of the wavelength selection switch, and limits a maximum channel number of the channel of the signal light output from the wavelength selection switch to the optical amplifier.

6. The network control device according to claim 1, wherein
the second wavelength division multiplexing device includes a wavelength selection switch that performs control to keep output power per unit frequency constant regardless of a symbol rate of an optical transmitter provided in the optical transmission and reception device and outputs a signal light to a downstream optical amplifier, and
the setting changer changes a slot width of the wavelength selection switch for the signal light of a channel relating to the transmission performance in the first transmission line to a slot width for increasing output power of the second wavelength division multiplexing device based on the transmission performance in the first transmission line.

7. The network control device according to claim 1, wherein
the setting changer changes a symbol rate of an optical transmitter provided in the optical transmission and reception device based on the transmission performance in the first transmission line.

8. The network control device according to claim 1, wherein
the calculator calculates a decrease amount of an optical signal to noise ratio of a signal light in the first transmission line.

9. The network control device according to claim 1, wherein
the first wavelength division multiplexing device includes a first optical device and a second optical device which are different from each other and are connected to each other by a first optical fiber,
each of the first transmission line and the second transmission line includes a second optical fiber different in type from the first optical fiber,
the optical transmission and reception device is connected to the first optical device via the first transmission line, and
the second wavelength division multiplexing device is connected to the second optical device via the second transmission line.

10. The network control device according to claim 1, wherein
the acquirer acquires the first information by using an optical supervisory channel light when acquiring the first information from the optical transmission and reception device, and acquires the first information by using an electric signal without using the optical supervisory channel light when acquiring the first information from the first wavelength division multiplexing device and the second wavelength division multiplexing device.

11. An optical network system comprising:
an optical transceiver;
a first wavelength division multiplexer connected to the transceiver via a first transmission line;
a second wavelength division multiplexer connected to the first wavelength division multiplexer via a second transmission line different from the first transmission 5 line; and
a network controller that acquires first information indicating a transmission state of each of the optical transceiver, the first wavelength division multiplexer, and the second wavelength division multiplexer from at least one of the optical transceiver, the first wavelength division multiplexer, and the second wavelength division 10 multiplexer, calculates transmission performance in the first transmission line based on the first information, and changes a setting of at least one of the optical transceiver, the first wavelength division multiplexer, and the second wavelength division multiplexer based on the transmission performance in the first transmission line.
